(19) United States
(12) Patent Application Publication
(10) Pub. No.: US 2018/0101839 A1
(43) Pub. Date: Apr. 12, 2018

(54) COIN JAR

(71) Applicants: MICHAEL J HAMELTON, COATESVILLE, PA (US); MICHAEL MILLARD, COATESVILLE, PA (US)

(72) Inventors: MICHAEL J HAMELTON, COATESVILLE, PA (US); MICHAEL MILLARD, COATESVILLE, PA (US)

(21) Appl. No.: 15/287,765

(22) Filed: Oct. 7, 2016

(51) Int. Cl. G06Q 20/34; G06K 19/06; G07F 19/00; G06Q 20/10

(52) U.S. Cl. CPC G06Q 20/349; G06Q 20/1085; G07F 19/203; G06K 19/06028

(57) ABSTRACT

The present invention relates to a coin card which enables the at least one user to create an exclusive commercial bank account in a commercial bank and the user is either provided with a computationally implemented method by the commercial bank or installs the computationally implemented method onto his/her smart device, wherein, the computationally implemented method enables the at least one user to create a profile. Herein, the user is enabled to scan his/her coin card issued by the commercial bank in the scanning machine and transfer the remaining currency after conducting a transaction with the remitter party or the cashier. The user is further enabled to look into his/her coin account by logging into his/her profile. The money in the virtual coin jar account enables the user to choose at least one option from the various user interface options available in the computationally implemented method or as a debit card to withdraw funds and make purchases from the collected funds from cash transactions in a commercial account.

### FIELD OF INVENTION

The present invention relates to a coin card which enables the at least one user to create a coin account in a commercial bank account, exclusively designed for coin storage wherein, the at least one user is either provided with a computationally implemented method provided by the commercial bank to be installed onto one's smart device, wherein, the computationally implemented method further enables the at least one user to create a profile to access the various functions of the coin card.

### BACKGROUND OF THE INVENTION

Trade with cash and coin has been in place for a long time, be it buying households goods from local vendors or shopping malls, paying for meals, paying for traveling fare, paying by cash on delivery of goods, cash and coin is in use frequently by individuals on a daily basis.

The main concern is the change in coin given at the conclusion of a transaction. Many people prefer not to deal in change, because of the physical characteristics of coins, they can be difficult to carry, slow to sort and count, and heavy in the pocket. Often time people carry a debit or credit card instead, which may charge the vendor a fee or the user a fee or interest on money lent through the card.

People collect coin money at their home and bring them to a commercial bank or private automated coin counting machine that receives loose coins which in turn converts these coins into a virtual deposit. There are many coin counting machines which count the coins, they have been reported to produce accounting errors which results in users losing money. Further there are service fees charged for counting loose coins and rolling coins for easy exchange is time consuming.

For the above mentioned reasons, the present invention provides the digital coin storage system which eliminates the use of carrying and receiving coins

### SUMMARY OF THE INVENTION

The main objective of the present invention is to overcome the limitations of the prior arts by providing a coin card that is enabled to receive digital currency given as change in cash transactions which eliminates the need of carrying and receiving coins.

The invention is for a digital coin storage system which enables the at least one user to create a financial account in at least one commercial bank, wherein the account is exclusively designed for receiving funds in amounts less than one dollar. The at least one user is issued a coin card from the commercial bank. When a cash transaction is conducted, the user presents the coin card to the cashier allowing the card to be connected to the register for the transfer of any change amounts to the user's financial account provided by at least one commercial bank. The exclusive commercial bank provides the at least one user with a computationally implemented method to install onto one's smart device or access from a networked terminal, which enables the at least one user to track one's coin card account. The user is then enabled to utilize the coin money in his/her virtual coin card account in various ways selecting from various user interface options available in the either computationally implemented method installed by the user onto one's smart device or other networked terminal. The user may transfer funds to a variety of accounts, including but not limited to a checking account, a savings account, an investment fund or charity. Additionally the user may withdraw collected funds directly from an (ATM) Automatic Teller Machine or use the card to debit the associated commercial bank account for purchases.

### BRIEF DESCRIPTION OF DRAWINGS:

For a more complete understanding of the embodiment(s), reference is now made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 illustrates the flow chart of the given invention according to an embodiment of the invention.

### DETAIL DESCRIPTION OF THE INVENTION:

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computationally implemented methods mentioned herein are incorporated herein in their entirety.

The present invention is for a coin card which enables the at least one user to create an account in at least one commercial bank, wherein the account is exclusively for the storage of change from cash transactions, wherein the account further enables the at least one user to transfer money from the coin account to another account. The coin card enables the at least one user to create an account in a commercial bank, wherein, the account is a debit/credit card account, however, the scope of the invention is not limited to this only. The commercial bank issues the at least one user with at least one coin card, wherein the coin card is preferably made up of plastic containing at least one identifying code, such as card number, signature panel, barcode or magnetized strip. The commercial bank provides the at least one user a computationally implemented method to install onto one's smart device to track one's coin card account, wherein, the installation takes place via various stores available, for example Google play store and App store also wherein, the smart device comprises a smart phone, laptop and/or computer or tablet and the scope of the smart device is not limited to this only but may also be accessed via a networked terminal. Further, the computationally implemented method enables the user to create a profile in the computationally implemented method with at least two information fields such as user name, email id, date of birth, account number, commercial bank name and branch name and contact number. The at least one user while making purchases with cash, scans the coin card issued to him/her by the commercial bank at the scanning machine informing that the change under a dollar left after the purchase is to be transferred to the at least one user's account for storage on the coin card. The at least one user pays for the goods purchased and the remitter party or the cashier returns the cash amount in full dollars to the at least one user and credits the remainder coins into the account of the at least one user. The at least one user is enabled to login into his/her profile either on the computationally implemented method that is provided by the commercial bank wherein, login is done using the login credentials (username and password). The computationally implemented methods enables the at least one user to look at all the cash that the at least one user has received from all transactions. The at least one user then has at least one choice of utilizing the money from various user options available in the computationally implemented method interface, wherein the at least one user's options enable either transferring the money from his/her coin card account to another commercial bank account, invest the money by withdrawing from the Automatic Teller Machine(ATM) or directly from the commercial bank, donate the money to the charity, or make a direct purchase, however the choice of utilizing money is not limited to this only.

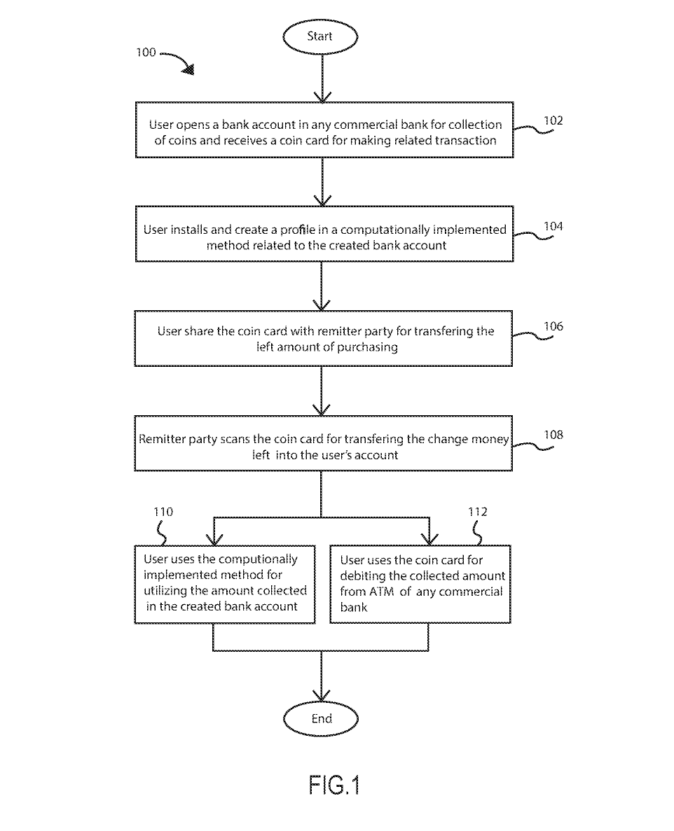

FIG. 1 illustrates the flow chart of the given invention according to an embodiment of the invention.

Step 1 of FIG. 1 [102] illustrates the providing of a coin card to at least one user via commercial bank in order to give the access to the exclusive commercial bank account opened for the coin storage during hard cash transaction at any store by at least one user. Herein the at least one user willing to make a coin storage account in any commercial bank is enabled to open an exclusive account at any commercial bank to save the left over coins at the time of the hard cash transaction. Further the at least one user is issued a coin card by the commercial bank for collecting coin cash payments from the remitter party or cashier, wherein the coin card is preferably made up of plastic containing at least one field of information, such as an account number, signature panel, barcode or a magnetized strip, however the scope of information fields is not limited to this only.

Step 2 of FIG. 1 [104] illustrates providing the at least one user's smart device with a computationally implemented method and creating a profile of the at least one user to generate a login/ID for the at least one user. Herein, the computationally implemented method enables the user to create a profile using at least two information fields such as user name, email id, date of birth, account number, commercial bank name, branch name and contact number. The at least one user then logs into his/her profile on the computationally implemented method provided by the commercial bank onto his/her smart device using his/her login credentials (username and password), wherein, logging in is done to check the account balance and activity associated with the coin card and previous transactions it involved.

Step 3 of FIG. 1 [106] illustrates sharing the coin card with a remitter party in order to enable the remitter party to transfer a left over amount after purchasing done by the at least one user, to an exclusive commercial bank account linked with the coin card.

Step 4 of FIG. 1 [108] illustrates scanning the coin card via remitter party, wherein scanning the coin card through the scanning machine informs the remitter party or the cashier to transfer the change money left after the purchase of the goods to the at least one user's coin account. The at least one user then pays for the goods purchased and the remitter party or the cashier returns the cash amount in whole dollars to the at least one user and credits the remainder amount that is less than a whole dollar into the account of the at least one user. The at least one user then logs into his/her profile on the computationally implemented method provided by the commercial bank or the computationally implemented method installed by the user onto his/her smart device using his/her login credentials (username and password), wherein, logging in is done to check all the money the user has received from all the transactions, and/or transfer or redeem funds.

Step 5a of FIG. 1 [110] & Step 5b of FIG. 1 [112] illustrates making a choice from a user interface via the at least one user, wherein the at least one user then has at least one choice to utilize the money in the account by selecting from the various user interface options available in the computationally implemented method such as transferring the money from his/her account to another commercial bank account, invest the money into a fund, donate the money to the charity [110], collect the money by withdrawing from the Automatic Teller Machine (ATM) or directly from the commercial bank or make purchases [112], however the choice of utilizing account funds is not limited to this only.

What is claimed is:

1. A method of operating a coin card, by at least one user, operable during a hard cash transaction, wherein the method comprising the steps of:
a. sharing the coin card with a remitter party in order to enable the remitter party to transfer a left over amount after purchasing done by the at least one user, to an exclusive commercial bank account linked with the coin card; and
b. enabling a computer implemented method on at least one user smart device to keep a status update of the exclusive commercial bank account associated with the coin card of at least one user.

2. The method of claim 1; wherein the coin card contains information of at least one of card number, signature panel, barcode, computer chip, a magnetized strip or the combination thereof.

3. The method of claim 1; wherein the coin card enables the at least one user to withdraw hard cash in exchange of the collected funds from the exclusive commercial bank account of the at least one user.

4. A coin storage system for hard cash transaction by at least one user comprises: a coin card that enables a remitter party to transfer a left over amount after purchasing is done by the at least one user, to an exclusive commercial bank account linked with the coin card; a computer implemented method on at least one user smart device to keep a status update of the exclusive commercial bank account associated with the coin card.

5. The coin storage system of claim 4; wherein the coin card contains information of at least one of card number, signature panel, barcode, a magnetized strip or the combination thereof.

6. The coin storage system of claim 4; wherein the coin card enables the at least one user to withdraw hard cash in exchange for the collected funds from the exclusive commercial bank account of the at least one user.

7. The coin storage system of claim 4; wherein the at least one user is provided with a login credential to operate the coin card related computationally implemented method on his/her smart device or networked terminal.

8. The coin storage system of claim 4; wherein the coin card enables the at least one user to withdraw hard cash in exchange for the collected funds from an Automated Teller Machine.

9. The coin storage system of claim 4; wherein the coin card enables the at least one user to provide payment with the coin card using the collected funds from the commercial bank account of the at least one user.
